(19) United States
(12) Patent Application Publication
(10) Pub. No.: US 2003/0099241 A1
(43) Pub. Date: May 29, 2003

(54) Method and apparatus providing a high-speed transport service in an AAL2 environment in a radio access network

(76) Inventors: Sami Kekki, Helsinki (FI); Jari Isokangas, Tampere (FI); Woonhee Hwang, Helsinki (FI); Sinikka Sarkkinen, Kangasala (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/300,690

(22) Filed: Nov. 19, 2002

Related U.S. Application Data
(60) Provisional application No. 60/333,412, filed on Nov. 26, 2001.

(51) Int. Cl. H04L 12/28

(52) U.S. Cl. 370/395.2

(57) ABSTRACT

A method and apparatus (14a 14b) for providing a high speed transport bearer (12a 12b), using end-to-end ATM adaptation layer type 2 (AAL2) signaling to set up the high speed transport bearer (12a 12b), for use by a user application (10a) hosted by a sending entity (19a) in communicating with a peer user application (10b) of a receiving entity (19b) over a network, in a way that uses multiple component connections (17a 17b) each providing only a fraction of the overall bit rate of the high speed transport bearer.

### CROSS REFERENCE To RELATED APPLICATIONS

Reference is made to and priority claimed from U.S. provisional application Ser. No. 60/333,412, filed Nov. 26, 2001, and entitled HIGH SPEED TRANSPORT SERVICE IN AAL2 ENVIRONMENT.

### TECHNICAL FIELD

The present invention relates to communication between elements of a radio access network (RAN), and more particularly to providing a high speed transport bearer (HSTB) for a user application hosted by an element of a RAN for communicating data from the user application to a peer user application hosted by another element of the RAN or by an element of a second RAN connected to the first RAN via a core network, or by an element of the core network.

### BACKGROUND ART

In the Third Generation Partnership Program (3GPP) Universal Mobile Telecommunications Service (UMTS), the so-called Asynchronous Transfer Mode (ATM) Adaptation Layer type 2 (AAL2) is used for communicating between elements of a network (including one or more RANs and any interconnecting core network) as the protocol in the transport network layer (TNL), i.e. in the layer of protocols that depends on the implementation of the network. Correspondingly, the AAL2 signaling protocol as defined by the International Telecommunication Union-Telecommunications Standardization Sector (ITU-T) in Q.2630 is used as the bearer control protocol, called the Access Link Control Application Protocol (ALCAP). Q.2630 limits the capacity of a single AAL2 connection to 2048 kbit/sec. However, in release 5, (Rel′5) of the UMTS Terrestrial Radio Applications Network (UTRAN), there is a new functionality for which the 2048 kbit/sec limitation acts as a bottleneck; the new functionality is high speed downlink packet access (HSDPA), which makes use of a new transport channel, the high speed downlink shared channel (HS-DSCH), having a capacity that is allowed to exceed and sometimes does exceed the 2048 kbit/sec limitation by a significant margin (a capacity that is expected to be up to 10 Mbit/s).

What is needed is a UTRAN transport service/bearer suitable for HS-DSCH but compatible with AAL2 signaling as specified by Q.2630.

### DISCLOSURE OF THE INVENTION

Accordingly, a first aspect of the invention is a method that provides a high speed transport bearer between two end points for use in communicating data from a first user application at a first one of the two end points to a peer user application at the other of the two end points, the method using end-to-end asynchronous transport mode (ATM) adaptation layer type 2 (AAL2) signaling to set up the high speed transport bearer, the high speed transport bearer having a capacity as requested by a node application at the first endpoint, the method characterized by: a step of setting a high speed transport bearer identifier; and a step of setting up component connections so as to be associated with the high speed transport bearer, the component connections having only in the aggregate the capacity requested by the node application.

In accord with the first aspect of the invention, in the step of setting the high speed transport bearer identifier, a value may be chosen for the high speed transport bearer identifier that is unique among all identifiers of transport bearers between the two end points.

Also in accord with the first aspect of the invention, in setting up each component connection, a step may be performed in which logic is determined for providing the high speed transport bearer and so enabling communication at the requested rate, and a step may be performed in which component connections are set up each having a different component connection identifier but all having the chosen value for the high speed transport bearer identifier.

Still also in accord with the first aspect of the invention, after being set up to provide a first bit rate, the high speed transport bearer may be able to be modified to provide a second bit rate, with the modification including: a step of determining a logic to be used in changing the existing high speed transport bearer so as to provide the second bit rate, the logic calling for either deleting a component connection, adding a new component connection, or modifying an existing component connection; and a step of carrying out the logic, including deleting component connections as set out by the logic, modifying existing component connections as set out by the logic, and adding new component connections as set out by the logic. Further, a step of sending a confirmation to the node application may be performed.

A second aspect of the invention is an apparatus for use as part of an element of a radio access network, the apparatus for providing a high speed transport bearer between two end points for use in communicating data from a first user application at a first one of the two end points to a peer user application at the other of the two end points, the apparatus using end-to-end asynchronous transport mode (ATM) adaptation layer type 2 (AAL2) signaling to set up the high speed transport bearer, the high speed transport bearer having a capacity as requested by a node application at the first endpoint, the apparatus comprising a convergence module including: means for setting a high speed transport bearer identifier; and means for setting up component connections so as to be associated with the high speed transport bearer, the component connections having only in the aggregate the capacity requested by the node application.

In accord with the first aspect of the invention, the means for setting the high speed transport bearer identifier may choose a value for the high speed transport bearer identifier that is unique among all identifiers of transport bearers between the two end points.

Also in accord with the first aspect of the invention. the means for setting up each component connection may determine logic for providing the high speed transport bearer and so enable communication at the requested rate, and may also set up component connections each having a different component connection identifier but all having the chosen value for the high speed transport bearer identifier.

Also still, in accord with the first aspect of the invention, the convergence module may also include: means for determining a logic to be used in changing the existing high speed transport bearer so as to provide a second bit rate, the logic calling for at least either deleting a component connection, adding a new component connection, or modifying an existing component connection; and means for carrying out the logic, including deleting component connections as set out by the logic, modifying existing component connections as set out by the logic, and adding new component connections as set out by the logic.

Still also in accord with the first aspect of the invention, the convergence module may also include means for sending a confirmation to the node application.

In a third aspect of the invention, a radio access network is provided including as elements a plurality of node Bs and a plurality of radio network controllers, characterized in that at least two of the elements include an apparatus according to the second aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram showing the invention as component modules of a TNL node;

FIG. 2 is a flow chart indicating the operation of the invention in setting up an HSTB; and

FIG. 3 is a flow chart illustrating the operation of the invention in modifying an existing HSTB.

### BEST MODE FOR CARRYING OUT THE INVENTION

The invention provides for UTRAN an HSTB service suitable for communicating (user or control) data via HS-DSCH, with the data being communicated using AAL2 signaling. However, it should be understood that the invention is also useful for other kinds of radio access networks as well as for other kinds of networks; it is of use in any network where AAL2 signaling is used and there is a need for high bit rate connections, such as for connection bit rates greater than 2 Mbit/s.

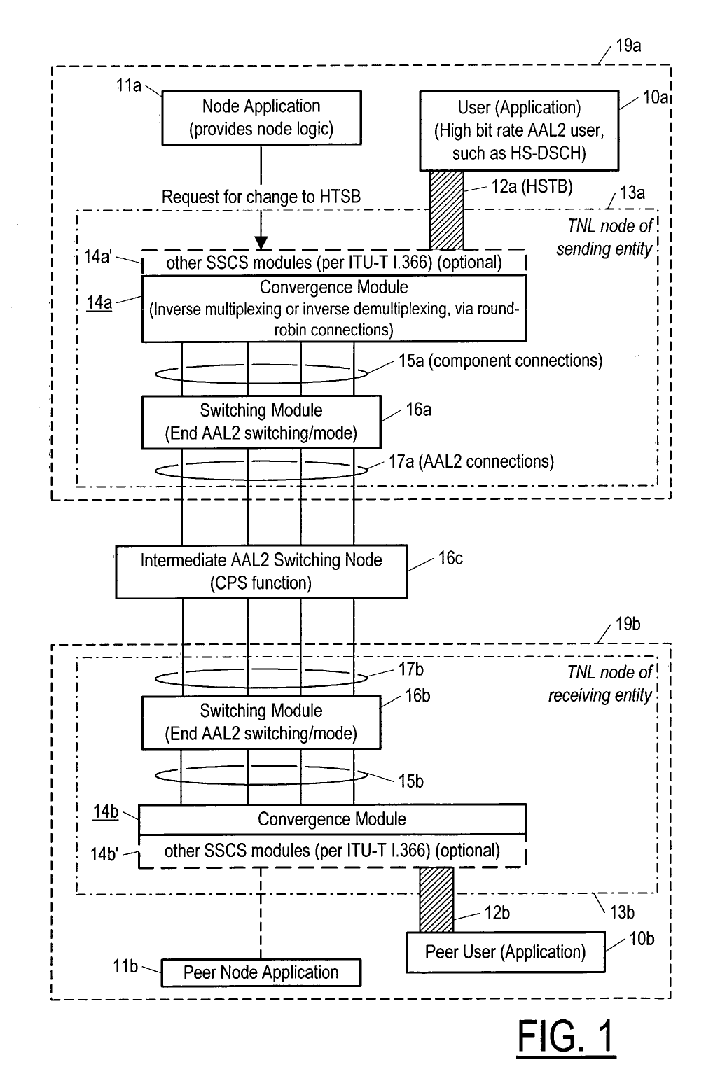

Referring now to FIG. 1, the invention is shown as a convergence module 14a, which implements a new AAL2 protocol sublayer that resides immediately below the other AAL2 protocol sublayers; the invention can be considered a new, additional Service Specific Convergence sublayer (SSCS), a sublayer in addition to already existing sublayers 14a′, such as the Service Specific Segmentation and Reassembly (SSSAR) sublayer and the Service Specific Transmission Error Detection (SSTED) sublayer, both defined in ITU-T I.366.1. The invented sublayer resides only in the connection endpoints.

Still referring to FIG. 1, the convergence module 14a of the invention is a component of a TNL node 13a of a (first) UTRAN entity 19a, such as either a (part of a) node B or a (part of a) radio network controller (RNC), acting as a UTRAN bearer terminating entity and including a switching module 16a. The convergence module 14a provides an HSTB (a service) 12a for a user (application) 10a hosted by the UTRAN entity 19a, a user application such as HS-DSCH. The invention also resides in the TNL node 13b of a second UTRAN entity 19b (also such as a node B or an RNC), the entity with which the first UTRAN entity is in communication, and as such provides a link between the user (application) 10a of the first entity 19a and the peer user (application) lob of the second entity 19b. For each element 10a-17a and 14a′of the first entity 19a, the second entity 19b of course includes a corresponding element 10b-17b and 14b′.

The convergence component/module 14a provides what is here called inverse multiplexing and inverse demultiplexing of AAL2 connections because it provides an HSTB 12a for use by the user (application) 10a although the high speed bearer service (the HSTB) is provided as a set of lower speed bearer connections; in other words, the convergence module 14a accepts data from the user application 10a at a high rate, but provides the high rate data to a switching module 16a via lower rate components 15a, components which the convergence module then uses to communicate the high rate data by applying the corresponding data signals to the component connections in round-robin fashion. The switching module 16a, which is an implementation of a sublayer of AAL2, maps the component connections to respective AAL2 connections 17a.

The HSTB 12a represents an instance of an HSTB service according to the invention; it can be considered a Service Access Point instance (SAP). The component connections 15a, the output of the sending convergence module 14a, are not yet actual AAL2 connections but instead are protocol independent in the sense that they can in principle be conveyed by any protocol(s) below the protocol layer implemented by the convergence module 14a, i.e. by any protocol that has a limitation on the maximum connection bit rate. The term “component” in the label “component connections” (indicating the component connections 15a of FIG. 1) refers to the transport service user side; the HSTB service, provided by the convergence module 14a, splits the data stream generated by a transport service user (e.g. HSDPA) into the component connections 15a. The switching module 16a maps the component connections 15a to AAL2 connections 17a that are each a standard AAL2 connection with all AAL2 specific Common Part Switching (CPS) Packet format and CPS Packet headers, etc.

At the receiving entity 19b, in the receiving TNL node 13i b, a switching module 16b maps AAL2 corresponding connections 17b to component connections 15b, and a convergence module 14b then recombines (i.e. inverse demultiplexes) the data provided by the component connections 15b so as to provide the data at again a high data rate, i.e. to provide in the receiving entity 19b an HSTB 12b corresponding to the HSTB 12a of the sending entity 19a. Thus, the convergence module 16a of the invention performs inverse multiplexing at the sending entity and the peer convergence module 16b at the receiving entity performs inverse demultiplexing.

If an intermediate node is involved in communicating the application data to the receiving entity 19b, the data being communicated is processed only by the switching component 16c of the intermediate node. Thus, the operation of the invention is transparent to any AAL2 switching node 16c intermediate between the two end points 11a 11b of the high speed AAL2 transport bearer 12a 12b provided by the invention. It is important to understand that the operation of the invention, because it is transparent to the user (application), is consistent with the UTRAN principle that the TNL be independent of the operation of the radio network layer (RNL), i.e. that any standard UTRAN RNL user (meaning the frame protocol connection conveying the user data stream, such as a HS-DSCH stream) can use the high speed service provided by the invention without taking into account details of the operation of the invention. From the TNL service user viewpoint, an AAL2 HSTB 12a 12b provided by the invention is an ordinary transport bearer as defined in 3GPP specifications.

As mentioned above, what is here called the convergence module 14a is an enhancement to (or addition to) the SSCS, which is a protocol sublayer in the ATM adaptation layer tasked with making suitable for a specific service what is known as the AAL Common Part, indicated here as the AAL2 switching modules 16a 16b and the intermediate AAL2 switching node 16c. At the intermediate AAL2 switching node 16c, only the Common Part Sublayer (CPS) functionality is needed. However, in the bearer terminating and originating nodes 19a 19b (i.e. the end nodes) there are typically other SSCS protocol-implementing modules along with the convergence module 14a providing an HSTB service according to the invention. In 3GPP UTRAN, only the SSSAR (Service Specific Segmentation and Reassembly) sublayer is used, as defined in TTU-T I.366.1, and it interfaces with the convergence module 14a and the HSTB user 10a, i.e. it resides between the convergence module 14a and the HSTB user. The HSTB module of the invention (the convergence module 14a) can be considered not only another SSCS sublayer but in a broader context, a module for enabling the splitting of a high speed stream into lower speed component streams independent of whatever transport protocol is used.

The invention requires some additional signaling from what is currently provided by ALCAP, the protocol used for setting up, modifying dynamically as needed, and tearing down AAL2 connections. (The additional signaling needed is preferably provided as an extension of ALCAP although, as an alternative, it can be provided as a protocol of the HSTB service provider, the convergence module 14a.) The added signaling must convey, between a sending convergence module 14a and a peer 14b, information sufficient for the peer to recognize that the connections 15b are in fact component connections, so that the peer convergence module 14b is to perform inverse demultiplexing of the data received over those connections. More specifically, the additional signaling must indicate that a component connection 15b belongs to a group of AAL2 connections that together make up the HSTB 12a 12b. In Q.2630 there is already an optional parameter referred to as SSCS information; it is used to identify the type and the capabilities of an AAL2 SSCS protocol. The present invention adds a new kind of SSCS information for each component connection in a bundle of component connections providing an HSTB, namely: an HSTB identifier, serving as a binding identifier and identifying the HSTB using an identifier that is unique for the two end points 11a 11b of the transport bearer 12a 12b; and a component connection identifier for identifying an individual component connection in the bundle.

The binding identifier, assigned by the TNL to each of the component connections of an HSTB, is used by the RNL application to relate a transport channel (such as the HS-DSCH) to its transport bearer (such as an AAL2 connection, or, in the present invention, an HSTB). As indicated above, for the bundle of AAL2 component connections making up an HSTB according to the invention, there is one common binding identifier, the HSTB identifier. In the TNL, in setting up the component connections of an HSTB, the ALCAP uses the same binding identifier for consecutive setups of the component connections, and only after all component connections are set up does it then signal to the RNL application that a (high speed) Transport Bearer has been set up and provide the RNL with the binding identifier for the HSTB. The signaling by the ALCAP to the RNL application uses the binding identifier in the same way as is currently specified in UMTS by 3GPP.

Currently, the AAL2 signaling protocol does not allow setting up several AAL2 connections at the same time, nor does the present invention require being able to do so; instead, for each AAL2 connection 17a corresponding to a component connection 15a, a separate connection establishment procedure must be carried out, one in which an Establish Request message is sent by an RNC via AAL2 switches to a Node B (over Iub) or to another RNC (over Iur) to the peer TNL (at the receiving RNC). Having to issue an Establish Request (and wait for an answer) for each AAL2 connection 17a corresponding to a component connection 15a significantly slows setting up an HSTB. Thus, it would be preferable if AAL2 connections could be set up simultaneously, i.e. in groups, without having to issue an established request message (and receive permission) for each connection of the group. It is anticipated that future ITU-T specifications will set out enhancements to the existing setup protocol and provide for multiple simultaneous AAL2 connection setups. As soon as AAL2 signalling supports establishing multiple AAL2 connections, the component connections belonging to an HSTB service instance are to be set up simultaneously, according to the invention.

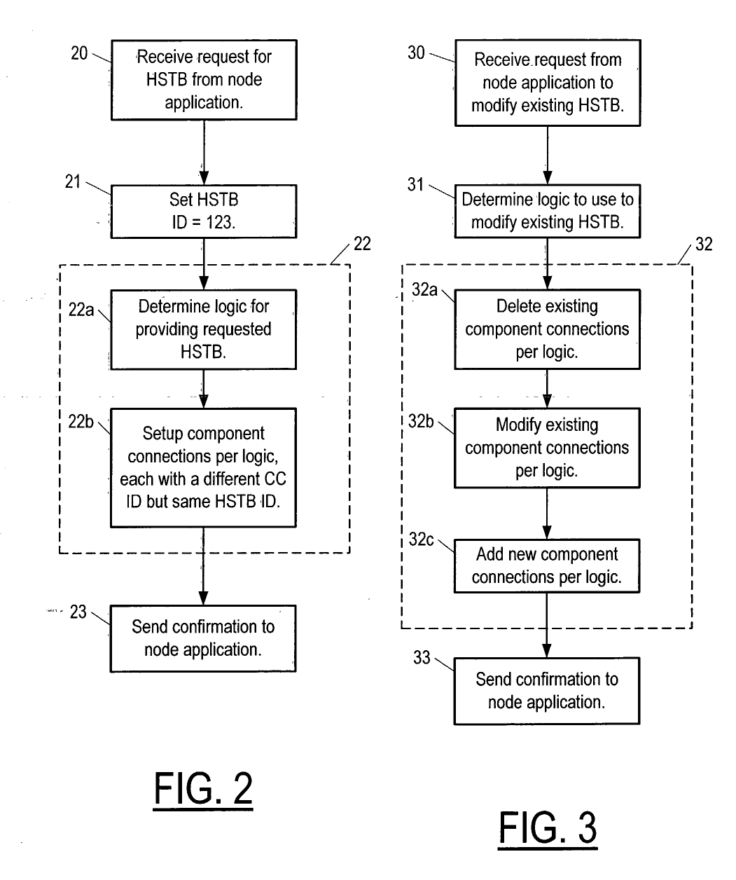

Referring now to FIG. 2, the setting up of an HSTB according to the invention is shown as including a step 20 in which the transport network layer 13a of a sending entity receives a request for an HSTB from the node application 11a. In a next step 21, the convergence module 14a of the TNL 13a of the sending entity sets an HSTB identifier to some suitably unique value, i.e. the convergence module 14a decides on the value to use for the HSTB it is about to establish. In a next step 22, the convergence module 14a sets up component connections so as to be associated with the HSTB identifier, and bundles the component connections together. More specifically, in a subset 22a, the convergence module 14a determines the logic for providing the requested HSTB, i.e. it determines what component connections are needed to provide the required capacity. In a next substep 22b, the convergence module 14a sets up the component connections per the decided on logic, each component connection having a different component connection identifier, but the same binding identifier (the HSTB identifier). In a next step 23, after all of the component connections are set up, the convergence module 14a sends a confirmation to the node application 11a, and provides the binding identifier to the user (application) according to the existing UMTS specifications.

Referring now to FIG. 3, the modifying of an existing HSTB to provide a different bit rate is shown as including a step 30 in which the sending TNL node 13a receives a request from the node application 11a (providing the node logic) to modify an existing HSTB. In a next step 31, the convergence module 14a of the TNL node 13a determines logic to use in modifying the existing HSTB, i.e. it determines what existing component connections to delete, what existing component connections to change, and what if any component connections to add, so as to provide the different bit rate. In a next step 32, the convergence module carries out the logic, including deleting any component connections set up by the logic (in a step 32a), modifying existing component connections as set out by the logic (in a step 32b) and adding new component connections according to the logic (in a step 32c). Finally, in a step 33, the convergence module 14a sends to the node application lla confirmation of the change in the bit rate of the HSTB being provided by the TNL node 13a. (In the signaling of the setting up of a connection and the changing of an existing connection, the TNL node of the sending entity also notifies the TNL node of the receiving entity so that the HSTB ID binds all actions to a specific HSTB.)

What is not shown, but which should be understood, is that whenever a new connection is created or an existing connection is changed (or terminated), end-to-end bearer control signaling is used to coordinate the connection arrangement. Thus, the TNL of the sending node notifies the TNL of the receiving node whenever a new connection is made, or an existing connection is changed (or terminated).

As would be appreciated by one skilled in the art, each of the steps indicated in FIGS. 2 and 3 can be carried out by corresponding modules of software stored on a ROM (read only memory) device or other non-volatile memory device and loaded into the RAM (random access memory) of a CPU (central processing unit) of e.g. a microprocessor. Thus, e.g. corresponding to the step 21 of FIG. 2, there is a corresponding module. The modules may be discrete, able to be executed by the CPU independently, or may be linked together into one single combined module or into several different combined modules.

It is to be understood that the above-described arrangements are only illustrative of the application of the principles of the present invention. Numerous further modifications and alternative arrangements besides those indicated above may be devised by those skilled in the art without departing from the scope of the present invention, and the appended claims are intended to cover such modifications and arrangements.

What is claimed is:

1. A method for providing a high speed transport bearer (12a 12b) between two end points (14a 14b) for use in communicating data from a first user application (10a) at a first one of the two end points (14a) to a peer user application (10b) at the other of the two end points (14b), the method using end-to-end asynchronous transport mode (ATM) adaptation layer type 2 (AAL2) signaling to set up the high speed transport bearer (12a 12b); the high speed transport bearer (12a 12b) having a capacity as requested by a node application (11a) at the first endpoint (14a), the method characterized by:
a step (21) of setting a high speed transport bearer identifier; and
a step (22) of setting up component connections (15a 15b) so as to be associated with the high speed transport bearer, the component connections having only in the aggregate the capacity requested by the node application (11a).

2. The method of claim 1, further characterized in that in the step (21) of setting the high speed transport bearer identifier, a value is chosen for the high speed transport bearer identifier that is unique among all identifiers of transport bearers between the two end points.

3. The method of claim 1, further characterized in that in setting up each component connection (15a 15b), a step (22a) is performed in which logic is determined for providing the high speed transport bearer and so enabling communication at the requested rate, and a step (22b) in which component connections (15a 15b) are set up each having a different component connection identifier but all having the chosen value for the high speed transport bearer identifier.

4. The method of claim 1, further characterized in that after being set up to provide a first bit rate, the high speed transport bearer (12a 12b) is able to be modified to provide a second bit rate, the modification including:
a step (31) of determining a logic to be used in changing the existing high speed transport bearer so as to provide the second bit rate, the logic calling for at least one action selected from the group of actions consisting of deleting a component connection (15a 15b), adding a new component connection (15a 15b), and modifying an existing component connection (15a 15b); and
a step (32) of carrying out the logic, including deleting component connections as set out by the logic, modifying existing component connections as set out by the logic, and adding new component connections as set out by the logic.

5. The method of claim 4, further characterized by a step of sending a confirmation to the node application (11a).

6. An apparatus (19a 19b) for use as part of an element of a radio access network, the apparatus (19a 19b) for providing a high speed transport bearer (12a 12b) between two end points (14a 14b) for use in communicating data from a first user application (10a) at a first one of the two end points (14a) to a peer user application (10b) at the other of the two end points (14b), the apparatus (19a 19b) using end-to-end asynchronous transport mode (ATM) adaptation layer type 2 (AAL2) signaling to set up the high speed transport bearer (12a 12b), the high speed transport bearer (12a 12b) having a capacity as requested by a node application (11a) at the first endpoint (14a), the apparatus comprising a convergence module (14a 14b) including:
means (21) for setting a high speed transport bearer identifier; and
means (22) for setting up component connections (15a 15b) so as to be associated with the high speed transport bearer, the component connections having only in the aggregate the capacity requested by the node application (11a).

7. The apparatus of claim 6, further characterized in that the means (21) for setting the high speed transport bearer identifier chooses a value for the high speed transport bearer identifier that is unique among all identifiers of transport bearers between the two end points.

8. The apparatus of claim 6, further characterized in that the means (22) for setting up each component connection (15a 15b) determines logic for providing the high speed transport bearer and so enables communication at the requested rate, and sets up component connections (15a 15b) each having a different component connection identifier but all having the chosen value for the high speed transport bearer identifier.

9. The apparatus of claim 6, further characterized in that the convergence module (14a 14b) also includes:
means (31) for determining a logic to be used in changing the existing high speed transport bearer so as to provide a second bit rate, the logic calling for at least one action selected from the group of actions consisting of deleting a component connection (15a 15b), adding a new component connection (15a 15b), and modifying an existing component connection (15a 15b); and
means (32) for carrying out the logic, including deleting component connections as set out by the logic, modifying existing component connections as set out by the logic, and adding new component connections as set out by the logic.

10. The apparatus of claim 9, further characterized in that the convergence module also includes means (23) for sending a confirmation to the node application (11a).

11. A radio access network including as elements a plurality of node Bs and a plurality of radio network controllers, characterized in that at least two of the elements include an apparatus as in claim 6.

12. A radio access network including as elements a plurality of node Bs and a plurality of radio network controllers, characterized in that at least two of the elements include an apparatus as in claim 7.

13. A radio access network including as elements a plurality of node Bs and a plurality of radio network controllers, characterized in that at least two of the elements include an apparatus as in claim 8.

14. A radio access network including as elements a plurality of node Bs and a plurality of radio network controllers, characterized in that at least two of the elements include an apparatus as in claim 9.

15. A radio access network including as elements a plurality of node Bs and a plurality of radio network controllers, characterized in that at least two of the elements include an apparatus as in claim 10.
